(19) United States
(12) Patent Application Publication
(10) Pub. No.: US 2024/0122425 A1
(43) Pub. Date: Apr. 18, 2024

(54) TOOL FOR CLEANING DEBRIS BETWEEN PAVER BLOCKS

(71) Applicant: Toolbro Innovators, LLC, Vernon, CT (US)

(72) Inventor: Philip J. Bahler, Vernon, CT (US)

(21) Appl. No.: 18/486,540

(22) Filed: Oct. 13, 2023

Related U.S. Application Data
(60) Provisional application No. 63/416,215, filed on Oct. 14, 2022.

(51) Int. Cl. A47L 9/06; A47L 7/00; A47L 9/00; A47L 9/24

(52) U.S. Cl. CPC A47L 9/066; A47L 7/00; A47L 9/009; A47L 9/0693; A47L 9/248

(57) ABSTRACT

A tool for cleaning debris from a joint between paver blocks laid over a ground, the tool having: a wand having an outer surface that defines a tubular profile, having an aft end that defines an aft end opening, a forward end that defines a forward end opening, and a middle section that connects the aft and forward ends, wherein the aft end is configured to connect to a vacuum suction port of a vacuum so that the vacuum is fluidly coupled to the aft end opening; and a pick connected to the forward end of the wand, wherein the pick extends below the forward end of the wand, whereby, in operation, the wand is configured for being moved over the joint to dislodge debris within the joint.

### CROSS REFERENCE

This application claims priority to U.S. 63/416,215 filed on Oct. 14, 2022, the entire contents of which is incorporated herein by reference in its entirety.

### BACKGROUND

Brick pavers are a strong material utilized for creating patios, garden paths, driveways and pool surrounds, as nonlimiting examples. Without maintenance, debris may buildup between paver joints. Frequent sweeping is one ways to remove debris from the pavers. However, over time, paver joints may become soiled with muddy shoes, windblown dirt, food spills, and standing water. The embodiments are directed to a tool for cleaning debris in the joints between paver blocks.

### BRIEF SUMMARY

Disclosed is a tool for cleaning debris from a joint between paver blocks laid over a ground, the tool including: a wand having an outer surface that defines a tubular profile, having an aft end that defines an aft end opening, a forward end that defines a forward end opening, and a middle section that connects the aft and forward ends, wherein the aft end is configured to connect to a vacuum suction port of a vacuum so that the vacuum is fluidly coupled to the aft end opening; and a pick connected to the forward end of the wand, wherein the pick extends below the forward end of the wand, whereby, in operation, the wand is configured for being moved over the joint to dislodge debris within the joint.

In addition to one or more aspects of the tool or as an alternate the forward end of the wand extends along a forward end axis; and the pick extends from an aft end to a forward end along a pick axis and the pick is connected to the wand and oriented so that the pick axis is disposed at an acute angle to the forward end axis of the wand, whereby the aft end of the pick extends below the forward end of the pick and the forward end of the wand, the forward end of the pick is above the aft end of the pick, and the aft end of the pick is further from the forward end opening of the wand than the forward end of the pick.

In addition to one or more aspects of the tool or as an alternate the pick is adjustable to move in a direction parallel to the pick axis, to thereby position the aft end of the pick at a selected distance below the forward end of the wand.

In addition to one or more aspects of the tool or as an alternate, the tool includes a first wheel, coupled to the forward end of the wand, wherein the first wheel is configured to support the forward end of the wand, and wherein the aft end of the pick is configured to extend below the first wheel, whereby, in operation, the pick extends into the joint.

In addition to one or more aspects of the tool or as an alternate, the tool includes a bracket, wherein the forward end of the wand, the first wheel, and the pick are connected to the bracket.

In addition to one or more aspects of the tool or as an alternate, the tool includes a clamp that secures the forward end of the wand to the bracket.

In addition to one or more aspects of the tool or as an alternate, the tool includes the bracket has a platform having forward end, an aft end that are opposite each other, a first end and a second end that are opposite each other, wherein the platform is oriented so that the forward end of the platform is closer to the forward end opening of the wand than the aft end of platform, and the first and second ends of the platform extend parallel to the forward end axis of the wand, and the clamp is connected to the platform of the bracket, along the first and second ends of the platform.

In addition to one or more aspects of the tool or as an alternate the bracket has a U-shape and includes: a first sidewall and a second sidewall that respectively extend downwardly from the first end and the second end of the platform; and the first wheel is connected to the first sidewall of the bracket to spin about a first wheel axis that is normal to the forward end axis of the wand.

In addition to one or more aspects of the tool or as an alternate, the tool includes a tube connected to first sidewall of the bracket, aft of the first wheel, and is oriented to position the pick along the pick axis, and the pick is fastened within the tube so that the aft end of the pick extends below the first wheel.

In addition to one or more aspects of the tool or as an alternate the first sidewall of the bracket has an aft end that is aft of the aft end of the platform to define an aft extension between the aft end of the platform and the aft end of the first sidewall; and the tube is connected to the aft extension of the first sidewall, at or near the aft end of the first sidewall.

In addition to one or more aspects of the tool or as an alternate the tube has an outer wall; and a threaded fastener extends through the outer wall of the tube to fasten the pick within the tube.

In addition to one or more aspects of the tool or as an alternate the pick includes spring steel.

In addition to one or more aspects of the tool or as an alternate, the tool includes a second wheel connected to the second sidewall of the bracket and configured to rotate about a second wheel axis that is coaxial with the first wheel axis.

In addition to one or more aspects of the tool or as an alternate the wand is an S-wand formed of a rigid material so that, in operation, the aft end of the wand is above the forward end of the wand; and the wand includes a vacuum nozzle connector secured to the forward end opening that is configured to receive a vacuum nozzle attachment.

In addition to one or more aspects of the tool or as an alternate the wand includes: an aft section that includes the aft end and an aft portion of the middle section; and a forward section that includes the forward end and a forward portion of the middle section, wherein the aft and forward sections of the wand are connected to each other via a quick release connection.

Disclosed is a vacuum, including a vacuum suction port; a tool having one or more of the above disclosed aspects, wherein the aft end of the wand is connected to the vacuum suction port so that the aft opening of the wand is fluidly coupled to the vacuum suction port.

Disclosed is a method of removing debris from a joint between paver blocks laid over a ground, the method including: connecting the aft end of the wand of the tool of claim 13 to a vacuum suction port of a vacuum; positioning the first and second wheels on the ground so that the forward end of the pick is aligned with the joint; turning on the vacuum and pivoting the wand about the first and second wheels so that the pick engages the joint; and moving the wand while the pick engages the joint to loosen or dislodge the debris from the joint, whereby the debris is suctioned into the vacuum via the wand.

In addition to one or more aspects of the method or as an alternate, the method includes attaching a vacuum nozzle attachment to the forward end of the wand prior to turning on the vacuum so that, in operation, loosened and dislodged debris is suctioned into the forward end opening of the wand by the vacuum.

In addition to one or more aspects of the method or as an alternate, the method includes adjusting a location of the pick within the tube to raise or lower the pick relative to the forward end of the wand.

In addition to one or more aspects of the method or as an alternate, prior to connecting the aft end of the wand to the vacuum suction port, the method includes: assembling the wand by connecting an aft section of the wand with the forward section of the wand via a quick release connection, wherein the aft section of the wand includes the aft end of the wand and an aft portion of the middle section of the wand, the forward section of the wand includes the forward end of the wand and a forward portion of the middle section of the wand.

### BRIEF DESCRIPTION OF THE DRAWINGS

The following descriptions should not be considered limiting in any way. With reference to the accompanying drawings, like elements are numbered alike:

FIG. 1 shows a tool used to clean debris within joints between paver blocks, along with a vacuum and a block layout that may be treated with the tool;

FIG. 2 shows additional aspects of a wand of the tool;

FIG. 3 is a perspective view of a section of the tool, showing a bracket that is connected to a tube clamp that secures the wand, a wheel and a joint pick;

FIG. 4 is a side view of the section of the tool shown in FIG. 3;

FIG. 5 is a rear view of the section of the tool shown in FIG. 3;

FIG. 6 is a bottom view of the section of the tool shown in FIG. 3;

FIG. 7 is a flowchart showing a method of cleaning debris from a joint between paver blocks utilizing the tool; and

FIG. 8 is another flowchart showing additional aspects of the method of removing debris from the joint between paver blocks laid over the ground.

### DETAILED DESCRIPTION

A detailed description of one or more embodiments of the disclosed apparatus and method are presented herein by way of exemplification and not limitation with reference to the Figures.

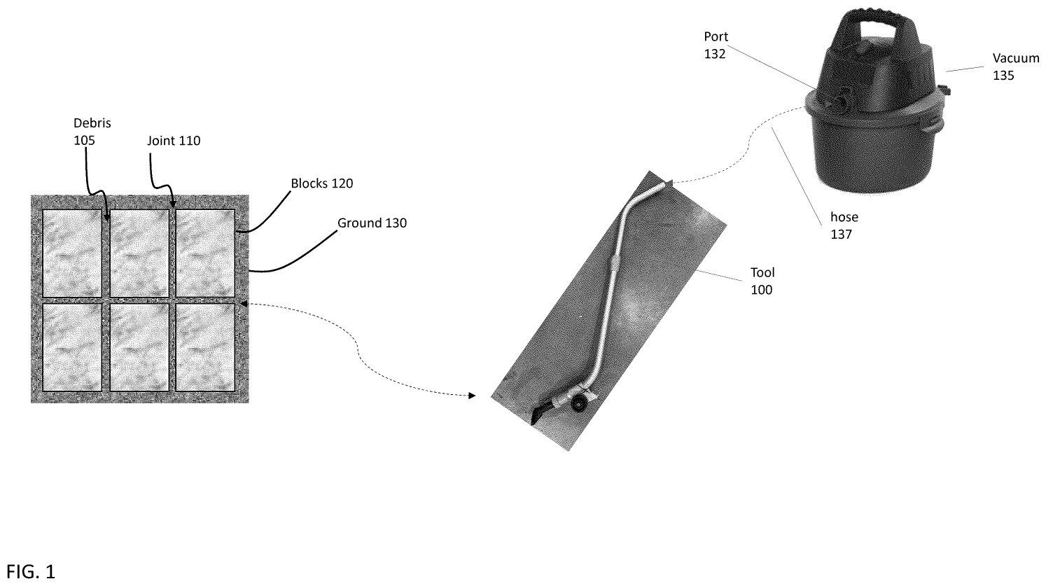

Turning to FIG. 1, a tool 100 is disclosed for cleaning debris 105 from a joint 110 between paver blocks 120 laid over a ground 130. The tool 100 is connected to a vacuum port 132 of a vacuum 135, directly or via, e.g. a flexible vacuum hose 137 (shown schematically), for applying suction to remove the debris 105.

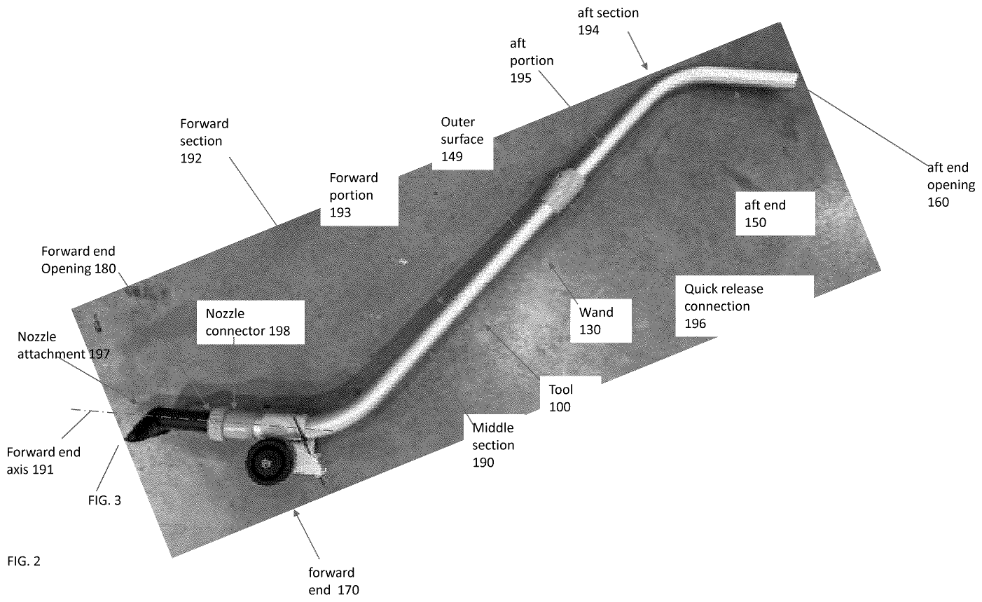

Turning to FIG. 2, the tool 100 includes a wand 130. The wand 130 has an outer surface 140 that defines a tubular profile. The wand 130 has an aft end 150 that defines an aft end opening 160. The wand 130 has a forward end 170 that defines a forward end opening 180. The wand 130 has a middle section 190 that connects the aft end 150 and the forward end 170. The aft end 150 of the wand 130 is configured to connect to the suction port 132 of the vacuum 135 (FIG. 1) so that the vacuum 135 is fluidly coupled to the aft end opening 160.

In one embodiment, the wand 130 is an S -wand so that, in operation, the aft end 150 of the wand 130 is above the forward end 170 of the wand 130. The wand 130 is formed of a rigid material such as metal or plastic. The aft end 150 and the forward end 170 of the wand 130 are linear sections that are parallel to each other. The forward end 170 of the wand 130 extends along a forward end axis 191 that, in operation, is parallel to the ground 130. The middle section 190 is a linear section that extends at an acute angle to the aft end 150 and the forward end 170.

In one embodiment, the wand 130 has a forward section 192 that includes the forward end 150 and a forward portion 193 of the middle section 190. The wand 130 has an aft section 194 that includes the aft end 170 and an aft portion 195 of the middle section 190. The forward section 192 and the aft section 194 are connected to each other via a quick release connection 196 or quick release sleeve.

The wand 130 includes a vacuum nozzle attachment 197 secured to the forward end opening 180. The vacuum nozzle connector 198 is configured to receive the nozzle attachment 197. The vacuum nozzle connector 198 may be a standard connector that is connected to a wand 130 of a vacuum 135.

Turning to FIGS. 3-6, the tool 100 has a pick 220 connected to the forward end 170 of the wand 130. The pick 220 extends below the forward end 170 of the wand 130. With this configuration, moving the wand 130 over the joint 110 dislodges debris 105 within the joint 110 (FIG. 1).

The pick 220 extends from an aft end 222 to a forward end 224 along a pick axis 235. The pick 220 is connected to the wand 130 and oriented so that the pick axis 235 is disposed at an acute angle to the forward end axis 191 of the wand 130. With this configuration, the aft end 222 of the pick 220 is aft of, and extends below, the forward end 224 of the pick 220 and the forward end 170 of the wand 130. Thus, in operation, the aft end 222 of the pick 220 is closer to the ground 130 than the forward end 224 of the pick 220.

The pick 220 is adjustable to move in a direction parallel to the pick axis 235. This configuration positions the aft end 222 of the pick 220 at a selected distance below the forward end 170 of the wand 130, and into the joint 110.

The tool 100 has a first wheel 240 and a second wheel 250. A configuration with fewer than or greater than two wheels is within the scope of the disclosure. The first wheel 240 and second wheel 250 are coupled to the forward end 170 of the wand 130. The first wheel 240 and second wheel 250 are configured to support the forward end 170 of the wand 130, e.g., above the ground 130 while moving the wand 130 over the joint 110. The aft end 222 of the pick 220 is configured to extend below the first wheel 240 and the second wheel 250. With this configuration, in operation, the pick 220 may extend into the joint 110 when the forward end 170 of the wand 130 is parallel to the ground 130 while the first wheel 240 and the second wheel 250 are against the ground 130.

The tool 100 includes a bracket 260. The forward end 170 of the wand 130, the first wheel 240 and the second wheel 250, and the pick 220 are connected to the bracket 260.

The tool 100 includes a clamp 270 that secures the forward end 170 of the wand 130 to the bracket 260. The clamp 270 may have the shape of an elongated pipe fastener. That is, the clamp 270 may have a body 275 with a generally arcuate or U-shaped cross-section with tabs 272 at opposite ends that are parallel to each other and extend outwardly from the body 275 for receiving fasteners 277 such as bolts.

As shown in greater detail in FIG. 6, the bracket 260 has a platform 280. The platform 280 has a forward end 290 and an aft end 300 that are opposite each other. The platform 280 has a first end 310 and a second end 320 that are opposite each other. The platform 280 is oriented so that the forward end 290 of the platform 280 is closer to the forward end opening 180 of the wand 130 than the aft 300 end of platform 280. The first and second ends 310 of the platform 280 extend parallel to the forward end axis 170 of the wand 130. With this configuration, the forward and aft ends 290, 300 of the platform 280 extend normal to the forward axis 170 of the wand 130. The clamp 270 is connected to the platform 280 of the bracket 260, along the first and second ends 310, 320 of the platform 280.

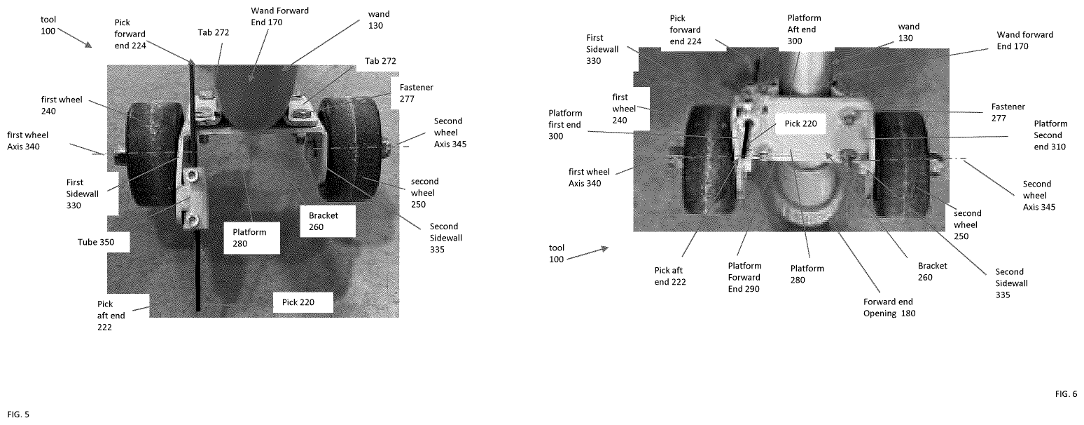

As shown in greater detail in FIGS. 5 and 6, the bracket 260 has a U-shaped cross section. The bracket 260 includes a first sidewall 330 and a second sidewall 335 that respectively extend downwardly from the first end 310 and the second end 320 of the platform 280. The first wheel 240 is connected to first sidewall 330 of the bracket 260 to spin about a first wheel axis 340 that is normal to the forward end axis 191 of the wand 130. The second wheel 250 is connected to the second sidewall 340 of the bracket 260 to spin about a second wheel axis 345 that is coaxial with the first wheel axis 340.

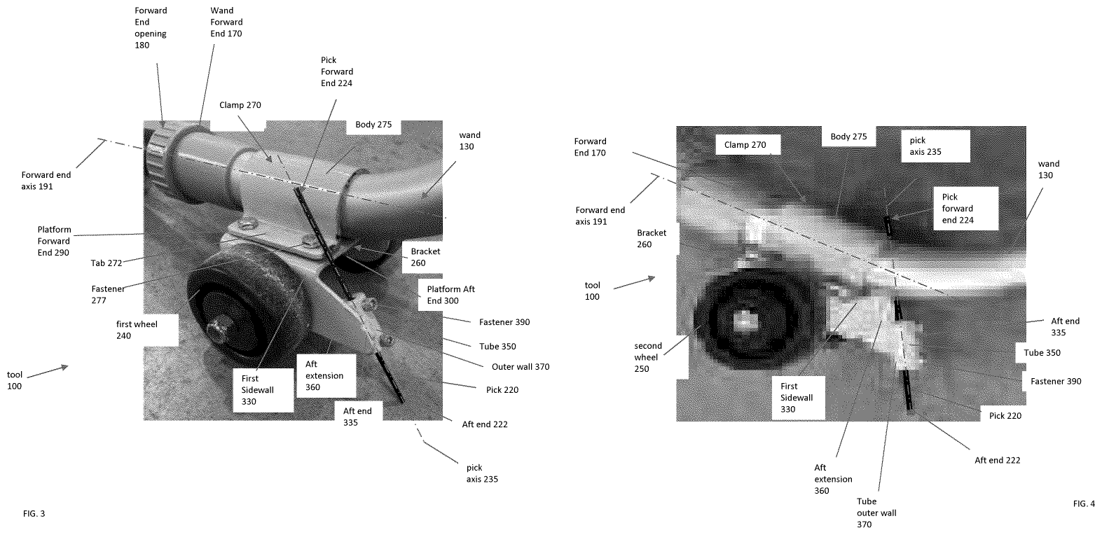

As shown in greater detail in FIGS. 3 and 4, the tool 100 includes a tube 350 connected to first sidewall 330 of the bracket 260, aft of the first wheel 240. The tube 350 is oriented to position the pick 220 along the pick axis 235. The forward end 290 of the platform 280 is common along the first and second sidewalls 330, 335. The aft end 300 of the platform 280 is common along the first sidewall 330. The first sidewall 330 of the bracket 260 has an aft end 335 that is aft of the aft end 300 of the platform 280. An aft extension 360 is defined between the aft end 300 of the platform 280 and the aft end 335 of the first sidewall 330. The tube 350 is connected to the aft extension 360 of the first sidewall 330 at the aft end 335 of the first sidewall 330.

The pick 220 is fastened within the tube 350 so that the aft end 224 of the pick 220 extends below the first wheel 240 and the second wheel 250. The tube 350 has an outer wall 370 and a threaded fastener 390 extends through the outer wall 370 of the tube 350 to fasten the pick 220 within the tube 350. As shown in the figures, there are two threaded apertures with two fasteners, though the figures are not intended on limiting the scope of the embodiments. In one embodiment, the pick 220 is formed of spring steel and the threaded fastener 390 engages an outer surface of the pick 220 to securely position the pick 220 within the tube 350.

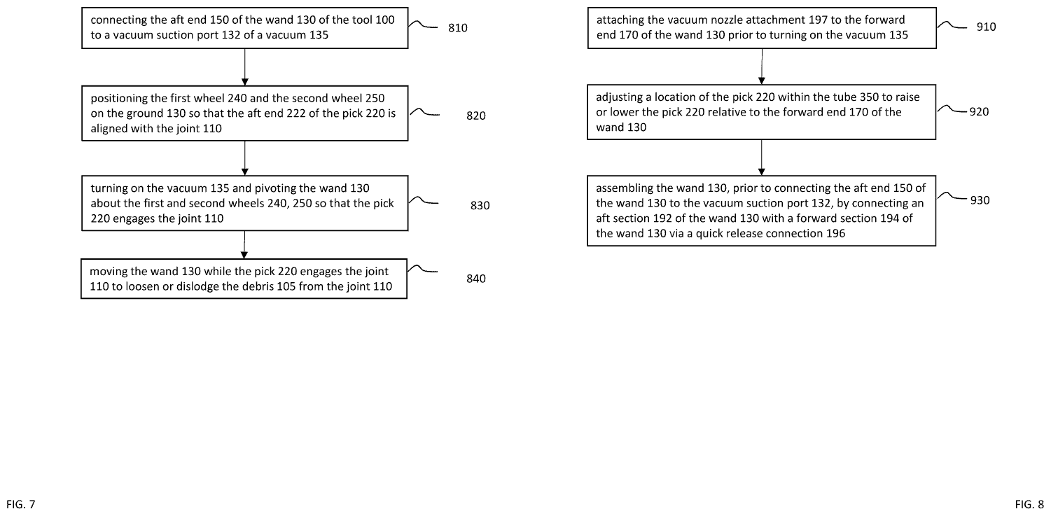

Turning to FIG. 7, a flowchart shows a method of removing debris 105 from the joint 110 between paver blocks 120 laid over the ground 130. As shown in block 810, the method includes connecting the aft end 150 of the wand 130 of the tool 100 to a vacuum suction port 132 of a vacuum 135. As shown in block 820 the method includes positioning the first wheel 240 and the second wheel 250 on the ground 130 so that the aft end 222 of the pick 220 is aligned with the joint 110. As shown in block 830, the method includes turning on the vacuum 135 and pivoting the wand 130 about the first and second wheels 240, 250 so that the pick 220 engages the joint 110. As shown in block 840, the method includes moving the wand 130 while the pick 220 engages the joint 110 to loosen or dislodge the debris 105 from the joint 110. From this action, the debris 105 is suctioned into the vacuum 135 via the wand 130.

Turning to FIG. 8, another flowchart shows additional aspects of the method of removing debris 105 from the joint 110 between paver blocks 120 laid over the ground 130. As shown in block 910, the method includes attaching the vacuum nozzle attachment 197, such as a brush attachment, to the forward end 170 of the wand 130 prior to turning on the vacuum 135 so that, in operation, loosened and dislodged debris 105 is swept into the forward end opening 180 of the wand 130 while the vacuum 135 is turned on. As shown in block 920, the method includes adjusting a location of the pick 220 within the tube 350 to raise or lower the pick 220 relative to the forward end 170 of the wand 130.

As shown in block 930, the method includes assembling the wand 130, prior to connecting the aft end 150 of the wand 130 to the vacuum suction port 132, by connecting an aft section 192 of the wand 130 with a forward section 194 of the wand 130 via a quick release connection 196. As indicated, the aft section 192 includes the aft end 150 and an aft portion 193 of the middle section 190 of the wand 130 and the forward section 194 includes the forward end 170 and a forward portion 195 of the middle section 190 of the wand 130.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

We claim:

1. A tool for cleaning debris from a joint between paver blocks laid over a ground, the tool comprising:
a wand having an outer surface that defines a tubular profile, having an aft end that defines an aft end opening, a forward end that defines a forward end opening, and a middle section that connects the aft and forward ends, wherein the aft end is configured to connect to a vacuum suction port of a vacuum so that the vacuum is fluidly coupled to the aft end opening; and
a pick connected to the forward end of the wand, wherein the pick extends below the forward end of the wand,
whereby, in operation, the wand is configured for being moved over the joint to dislodge debris within the joint.

2. The tool of claim 1, wherein:
the forward end of the wand extends along a forward end axis; and
the pick extends from an aft end to a forward end along a pick axis and the pick is connected to the wand and oriented so that the pick axis is disposed at an acute angle to the forward end axis of the wand,
whereby the aft end of the pick is aft of, and extends below, the forward end of the pick and the forward end of the wand.

3. The tool of claim 2, wherein:
the pick is adjustable to move in a direction parallel to the pick axis, to thereby position the aft end of the pick at a selected distance below the forward end of the wand.

4. The tool of claim 3, comprising:
a first wheel, coupled to the forward end of the wand,
wherein the first wheel is configured to support the forward end of the wand, and
wherein the aft end of the pick is configured to extend below the first wheel,
whereby, in operation, the pick extends into the joint.

5. The tool of claim 4, comprising:
a bracket, wherein the forward end of the wand, the first wheel, and the pick are connected to the bracket.

6. The tool of claim 5, comprising:
a clamp that secures the forward end of the wand to the bracket.

7. The tool of claim 6, wherein:
the bracket has a platform having forward end, an aft end that are opposite each other, a first end and a second end that are opposite each other,
wherein the platform is oriented so that the forward end of the platform is closer to the forward end opening of the wand than the aft end of platform, and the first and second ends of the platform extend parallel to the forward end axis of the wand, and
the clamp is connected to the platform of the bracket, along the first and second ends of the platform.

8. The tool of claim 7, wherein:
the bracket has a U-shape and includes:
a first sidewall and a second sidewall that respectively extend downwardly from the first end and the second end of the platform; and
the first wheel is connected to the first sidewall of the bracket to spin about a first wheel axis that is normal to the forward end axis of the wand.

9. The tool of claim 8, comprising:
a tube connected to first sidewall of the bracket, aft of the first wheel, and is oriented to position the pick along the pick axis; and
the pick is fastened within the tube so that the aft end of the pick extends below the first wheel.

10. The tool of claim 9, wherein:
the first sidewall of the bracket has an aft end that is aft of the aft end of the platform to define an aft extension between the aft end of the platform and the aft end of the first sidewall; and
the tube is connected to the aft extension of the first sidewall, at or near the aft end of the first sidewall.

11. The tool of claim 10, wherein:
the tube has an outer; and
a threaded fastener extends through the outer wall of the tube to fasten the pick within the tube.

12. The tool of claim 11, wherein the pick comprises spring steel.

13. The tool of claim 12, further comprising:
a second wheel connected to the second sidewall of the bracket and configured to rotate about a second wheel axis that is coaxial with the first wheel axis.

14. The tool of claim 1, wherein:
the wand is an S-wand formed of a rigid material so that, in operation, the aft end of the wand is above the forward end of the wand; and
the wand includes a vacuum nozzle connector secured to the forward end opening that is configured to receive a vacuum nozzle attachment.

15. The tool of claim 1, wherein:
the wand includes:
an aft section that includes the aft end and an aft portion of the middle section; and
a forward section that includes the forward end and a forward portion of the middle section,
wherein the aft and forward sections of the wand are connected to each other via a quick release connection.

16. A vacuum comprising:
a vacuum suction port;
the tool of claim 1, wherein the aft end of the wand is connected to the vacuum suction port so that the aft opening of the wand is fluidly coupled to the vacuum suction port.

17. A method of removing debris from a joint between paver blocks laid over a ground, the method comprising:
connecting the aft end of the wand of the tool of claim 13 to a vacuum suction port of a vacuum;
positioning the first and second wheels on the ground so that the forward end of the pick is aligned with the joint;
turning on the vacuum and pivoting the wand about the first and second wheels so that the pick engages the joint; and
moving the wand while the pick engages the joint to loosen or dislodge the debris from the joint, whereby the debris is suctioned into the vacuum via the wand.

18. The method of claim 17, further comprising:
attaching a vacuum nozzle attachment to the forward end of the wand prior to turning on the vacuum so that, in operation, loosened and dislodged debris is suctioned into the forward end opening of the wand by the vacuum.

19. The method of claim 17, including:
adjusting a location of the pick within the tube to raise or lower the pick relative to the forward end of the wand.

20. The method of claim 17, wherein prior to connecting the aft end of the wand to the vacuum suction port, the method includes:
assembling the wand by connecting an aft section of the wand with the forward section of the wand via a quick release connection,
wherein the aft section of the wand includes the aft end of the wand and an aft portion of the middle section of the wand, the forward section of the wand includes the forward end of the wand and a forward portion of the middle section of the wand.
